(19) United States
(12) Patent Application Publication
(10) Pub. No.: US 2022/0147713 A1
(43) Pub. Date: May 12, 2022

(54) SOCIAL BIAS MITIGATION IN TEXTUAL MODELS

(71) Applicant: Adobe Inc., San Jose, CA (US)

(72) Inventors: Aparna Garimella, Hyderabad (IN); Kiran Kumar Rathlavath, Badangpet (IN); Balaji Vasan Srinivasan, Bangalore (IN); Anandhavelu Natarajan, Kangayam (IN); Akhash Nakkonda Amarnath, Chennai (IN); Akash Pramod Yalla, Kakinada (IN)

(73) Assignee: Adobe Inc., San Jose, CA (US)

(21) Appl. No.: 17/092,230

(22) Filed: Nov. 7, 2020

(51) Int. Cl. G06F 40/284; G06F 40/56; G06K 9/62

(52) U.S. Cl. CPC G06F 40/284; G06K 9/6218; G06F 40/56

(57) ABSTRACT

A system for generating text using a trained language model comprises an encoder that includes a debiased language model that penalizes generated text based on an equalization loss that quantifies first and second probabilities of respective first and second tokens occurring at a first point in the generated text. The first and second tokens define respective first and second groups of people. The system further comprises a decoder configured to generate text using the debiased language model. The decoder is further configured to penalize the generated text based on a bias penalization loss that quantifies respective probabilities of the first and second tokens co-occurring with a generated word. The encoder and decoder are trained to produce the generated text using a task-specific training corpus.

### FIELD OF THE DISCLOSURE

This disclosure relates generally to mitigation of social bias in language models that use machine learning algorithms, and more specifically to methods for training and using such language models in a way that mitigates the degree of social bias reflected in model output.

### BACKGROUND

Language models trained using machine learning algorithms are used for natural language processing tasks such as text prediction, text generation, question answering, summarization, paraphrasing, translation, speech recognition, and sentiment analysis. At a fundamental level, these language models perform tasks based on a determination of the probability of a particular sequence of words. Machine learning algorithms are used to train language models on large textual corpora from which it is possible to derive general linguistic knowledge in the form of contextual relations between words. Training corpora are compiled by collecting a large volume of textual material from sources such as encyclopedias, books, webpages, and news articles, and often include hundreds of millions or even billions of words. Examples of popular language models that use machine learning algorithms to extract linguistic information from a large training corpus include: Bidirectional Encoder Representation from Transformers (“BERT”), as disclosed in Delvin et al., “BERT: Pre-training of Deep Bidirectional Transformers for Language Understanding”, Proceedings of the 2019 Conference of the North American Chapter of the Association for Computational Linguistics: Human Language Technologies, pages 4171-4186 (2019); Embeddings from Language Models (“ELMo”), as disclosed in Peters et al., “Deep Contextualized Word Representations”, Proceedings of the 2018 Conference of the North American Chapter of the Association for Computational Linguistics: Human Language Technologies, volume 1 (Long Papers), pages 2227-2237 (2018); and Generative Pre-Training (“GPT”), as disclosed in Radford et al., “Improving Language Understanding by Generative Pre-Training”, https://cdn.openai.com/research-covers/language-unsupervised/language_under-standing_paper.pdf (2018).

While a large textual corpus provides a valuable source of linguistic knowledge that can be used to train a language model, such a corpus will also include the social biases of the human authors who created the content that forms the corpus. Such social biases reflect preference toward, or prejudice against, a specific individual, group, community, or other demographic group such as race, ethnicity, gender, age, or religion. Social biases that exist in a textual corpus will be incorporated into, and sometimes even amplified by, a language model trained on that corpus. As a result, textual recommendation, prediction, or generation tools that rely on such models may generate output that perpetuates social biases, reinforces stereotypes, or otherwise offends certain communities. A language model that produces biased, opinionated, objectionable, or offensive content will have limited utility for tasks such as text generation or summarization.

Existing attempts to mitigate social bias in language models have produced unsatisfactory results. Curating large training corpora which have been filtered of any offensive, objectionable, or otherwise biased content is not feasible. In addition, bias mitigation techniques that use word-level language models typically require retraining, which can be computationally expensive when applied to contextual language models. See, for example, Liang et al., “Towards Debiasing Sentence Representations”, Proceedings of the 58th Annual Meeting of the Association of Computational Linguistics, pages 5502-5515 (2020). Existing bias mitigation techniques that use contextual language models have attempted to debias model output as a post-processing operation, but such approaches have been unable to adequately mitigate subtle biases. In particular, such “post-processing” operations still produce results having word clusters stereotypically associated with a particular group (for example, female or male). Other solutions have attempted to mitigate bias in context-free representations by defining a bias subspace, estimating bias in a word embedding as a projection onto the subspace, and developing algorithms to debias the word embeddings. However, techniques that disregard context and that rely on isolated embedding spaces also cannot adequately mitigate the profound and systematic biases that result from world stereotypes. See, for example, Gonen et al., “Lipstick on a Pig: Debiasing Methods Cover up Systematic Gender Biases in Word Embeddings But do not Remove Them”, Proceedings of the 2019 Conference of the North American Chapter of the Association for Computational Linguistics: Human Language Technologies, pages 609-614 (2019).

### SUMMARY

Disclosed herein are various loss functions that penalize social biases that exist in a contextual language model trained using a large textual corpus. In particular, an equalization loss function attempts to equalize the associations of words that are nominally neutral (for example, “doctor”) with words that define a group (for example, “she” or “he”). And a de-clustering loss function attempts to mitigate word clustering that is stereotypically associated with a particular group, for example by de-clustering words observed as being frequently associated with African or Caucasian. One or both of these loss functions is incorporated into a pretrained contextual language model, such as BERT, ELMo, or GPT, which is then retrained on a significantly smaller training corpus to produce a “debiased” language model. Also disclosed herein is a bias penalization loss function that can be incorporated into a decoder that is used in conjunction with a debiased language model for text generation tasks.

In contrast to existing post-processing bias mitigation techniques, the disclosed “in-training” approach to bias mitigation in a contextual language model provides improved results without degrading the quality of the generated text. In particular, in-training debiasing is observed to result in more effective debiasing and de-clustering as compared to existing post-processing techniques. Likewise, incorporating a bias penalization loss in a decoder results in significantly lower bias levels in generated text than existing encoder-decoder models. And because the language model is retrained using a smaller training corpus, the bias mitigation techniques disclosed herein do not carry a substantial computational burden.

Also disclosed herein is a “constrained cooccurrence score” that can be used to estimate the degree of social bias present in a language model. The constrained cooccurrence score can be used, for example, to evaluate the degree of social bias embedded in text generated from tasks including, but not limited to, fill-in-the-blank sentence completion, abstractive summarization, and extractive summarization.

### BRIEF DESCRIPTION OF THE DRAWINGS

FIG. 1 is a block diagram that schematically illustrates an example framework for training and using a language model in a way that mitigates the degree of social bias reflected in text generated using the language model.

FIG. 2 is a block diagram that schematically illustrates an example framework for debiasing a language model through the use of an equalization loss function and a de-clustering loss function.

FIG. 3 is a flowchart that illustrates an example method for debiasing a language model using an equalization loss function and a de-clustering loss function.

FIG. 4 is a block diagram that schematically illustrates an example framework for debiasing a language decoder through the use of a bias penalization loss function, and for using the debiased language decoder to complete a text generation task.

FIG. 5 is a flowchart that illustrates an example method for debiasing a language decoder using a bias penalization loss function, and for using the debiased language decoder to complete a text generation task.

FIG. 6 is a block diagram that illustrates an example computing environment configured for training and using a debiased language model in a way that mitigates the degree of social bias reflected in text generated using the model.

FIG. 7A is a word embedding scatter diagram illustrating spatial relationships of selected words having gender associations as defined by a language model that does not include debiasing loss functions.

FIG. 7B is a word embedding scatter diagram illustrating spatial relationships of selected words having gender associations as defined by a debiased language model that includes debiasing loss functions.

FIG. 8A is a word embedding scatter diagram illustrating spatial relationships of selected words having racial associations as defined by a language model that does not include debiasing loss functions.

FIG. 8B is a word embedding scatter diagram illustrating spatial relationships of selected words having racial associations as defined by a debiased language model that includes debiasing loss functions.

### DETAILED DESCRIPTION

As noted above, while a large textual corpus provides a valuable source of linguistic knowledge that can be used to train a language model, such a corpus will also incorporate the social biases of the human authors who created the content that forms the corpus. Textual recommendation, prediction, or generation tools that rely on such models may generate output that perpetuates those social biases, reinforces stereotypes, or otherwise offends certain communities. To address this problem, disclosed herein is a framework for debiasing a pretrained language model through the use of an equalization loss function and/or a de-clustering loss function. The inputs to such a model debiasing framework are (a) an existing language model having been previously trained using a relatively large training corpus; (b) a relatively small training corpus; and (c) a list of “dimension definitional word pairs” that are representative of the various groups with respect to which bias is to be mitigated. Examples of dimension definitional word pairs are {she, he} and {woman, man} for the gender dimension; and {black, white} and {African, Caucasian} for the race dimension. The existing language model is modified to include the equalization and/or de-clustering loss functions, and is further trained on the relatively small training corpus. The result is a modified version of the input language model that is referred to herein as a debiased language model. It will be appreciated that a debiased language model does not necessarily reflect a complete absence of bias, but rather reflects a reduced amount of bias as compared to a language model that does not include the aforementioned loss functions.

Also disclosed herein is a framework for debiasing a language decoder through the use of a bias penalization loss function. The inputs to such a decoder debiasing framework are (a) a task-specific training corpus, such as text that is to be summarized; and (b) a list of dimension definitional word pairs that are representative of the various groups with respect to which bias is to be mitigated. The existing decoder is modified to include the bias penalization loss function and is trained, with a corresponding encoder, on the task-specific training corpus. In some implementations the corresponding encoder is the aforementioned debiased language model, while in other implementations the corresponding encoder is a language model that has not been debiased. The resulting encoder-decoder is capable of performing text generation tasks that result in mitigated levels of bias in the generated text. Examples of such text generation tasks include fill-in-the-blank sentence completion, abstractive summarization, and extractive summarization (also referred to as “sentence highlighting”).

Certain implementations of the different debiasing frameworks disclosed herein address shortcomings of existing bias mitigation techniques. For example, bias mitigation techniques that use word-level language models typically require retraining, which can be computationally expensive when applied to contextual language models. In contrast, incorporating the disclosed equalization and/or de-clustering loss functions into a contextual language model allows the model to be retrained using a much smaller training corpus that imposes a correspondingly smaller computational burden.

Beyond the improvements in computational efficiency, the different debiasing frameworks disclosed herein have been found to be more effective in mitigating the degree of social bias evident in model output. For example, bias mitigation techniques that use word-level language models fail to adequately account for context and place excessive reliance on isolated embedding spaces. Existing bias mitigation techniques that have attempted to debias sentence representations as a post-processing operation on results generated by contextual language models (such as BERT, ELMo, and GPT) have been unable to adequately mitigate subtle biases. In particular, these post-processing bias mitigation techniques still produce results having word clusters stereotypically associated with a particular group (for example, female or male).

In contrast, a language model that has been retrained using the equalization and de-clustering loss functions disclosed herein has been found to incorporate mitigated levels of social bias as measured by a number of metrics. When such a debiased language model is used in conjunction with a decoder that also incorporates a debiasing objective, such as via the bias penalization loss function disclosed herein, it is possible to generate text having significantly reduced levels of social bias. Applying this in-training approach to a contextual language model avoids excessive reliance on isolated embedding spaces and helps to mitigate the extent to which subtle biases are embedded into the retrained model.

A wide range of benefits can be derived from a language model and an encoder-decoder architecture that has been specifically configured to generate text having mitigated levels of social bias. Language models are growing increasingly ubiquitous, and are often used for tasks such as text prediction, text generation, question answering, summarization, paraphrasing, translation, speech recognition, and sentiment analysis. A language model that could potentially generate output that perpetuates social biases, reinforces stereotypes, or that is otherwise offensive will have limited application. By mitigating the degree of social bias reflected in model output, the various techniques disclosed herein can make language modeling a viable solution for a wide range of applications.

While certain of the example implementations disclosed herein are described in the context of gender debiasing between two groups (female and male) or race debiasing between two groups (Black and Caucasian), other types of debiasing can be used in other embodiments, such as age, location, ethnicity, religion, and national origin debiasing. These other types of debiasing can be accomplished by using different dimension definitional word pairs, as disclosed herein. In addition, the debiasing techniques can be applied to more than two groups. For example, in the case of race debiasing, debiasing can be performed with respect to multiple racial groups by using standard deviations instead of probability ratios when determining equalization loss, de-clustering loss, and bias penalization loss. In particular, a standard deviation can be minimized instead of a sum of probability ratios. These and other alternative implementations will be apparent in view of the foregoing disclosure.

Implementation Environment

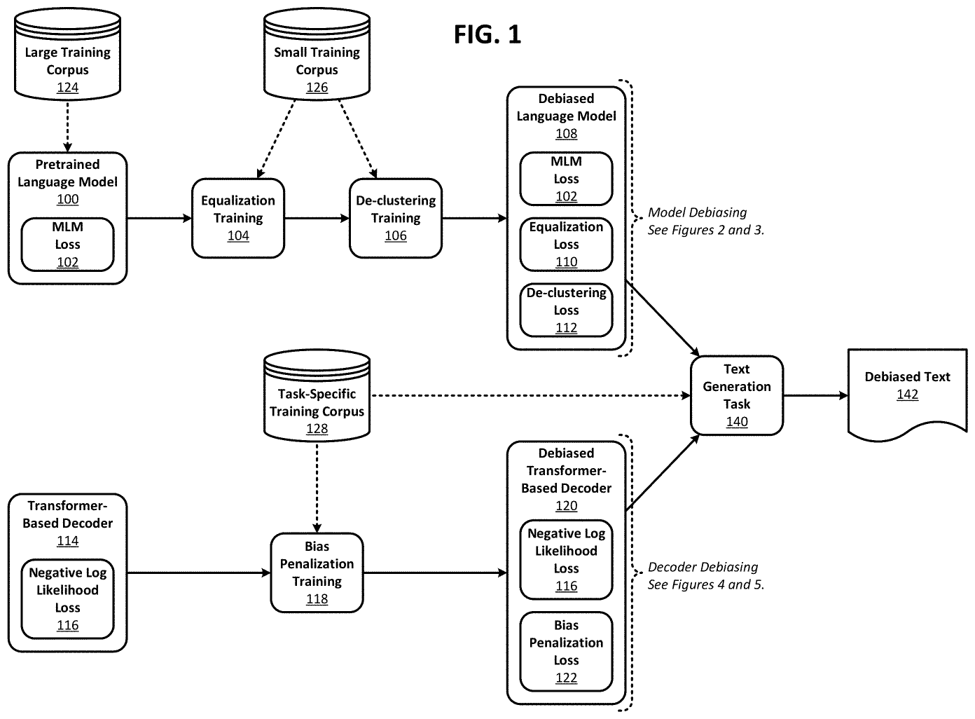

FIG. 1 is a block diagram that schematically illustrates an example framework for training and using a language model in a way that mitigates the degree of social bias reflected in text generated using the language model. In particular, FIG. 1 illustrates a pretrained language model 100 that is trained using a large training corpus 124. In one implementation pretrained language model 100 is a language model that uses a transformer-based encoder architecture to learn general linguistic knowledge in the form of contextual relations or associations between words in text. One example of such a model is the aforementioned BERT model, which includes a masked language modeling (“MLM”) objective, as represented by MLM loss 102. MLM names bidirectional training of a language model in which an attention mechanism reads an entire sequence of words at once, thus enabling the model to learn the context of a particular word based on words to both the left and right of the particular word. Other example pretrained language models include the aforementioned ELMo and GPT models, as well as other language models that work on a masked learning objective. Large training corpus 124 comprises a large volume of textual material from sources such as encyclopedias, books, webpages, and news articles, and will typically include hundreds of millions or even billions of words.

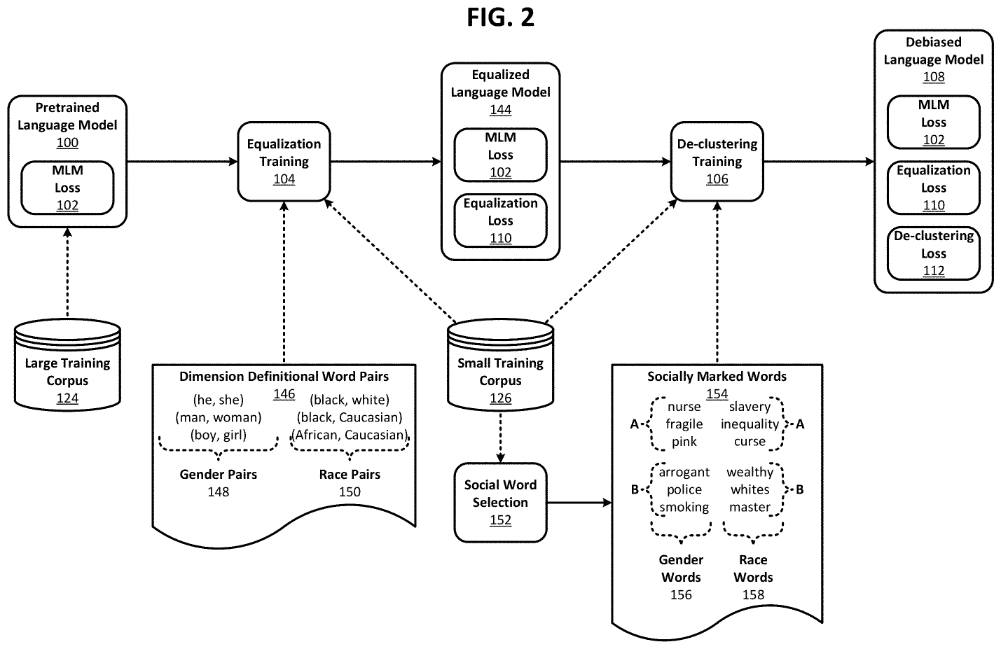

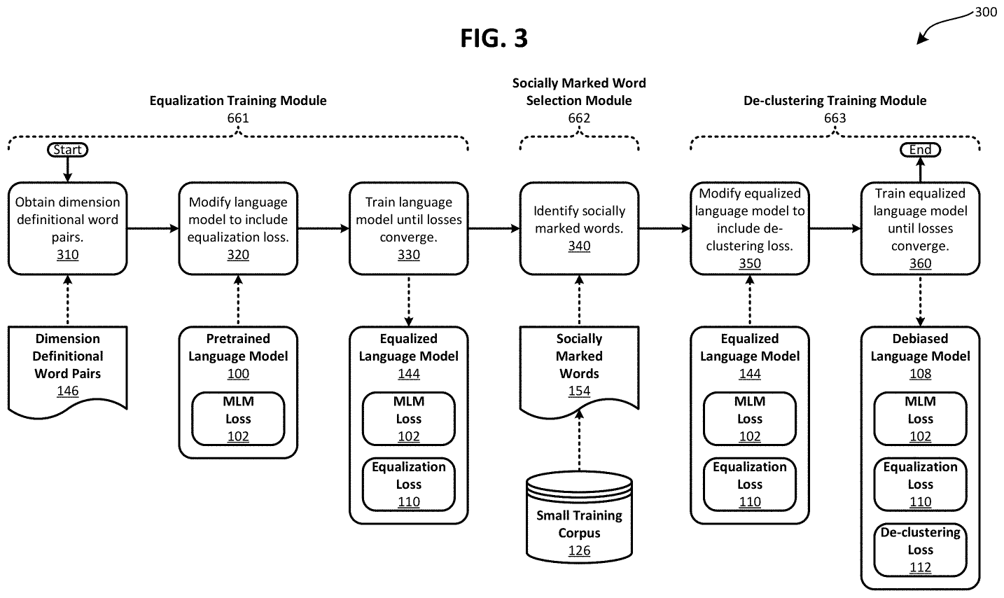

In one implementation pretrained language model 100 undergoes equalization training 104 and/or de-clustering training 106. Equalization training 104 involves incorporating an equalization loss 110 into pretrained language model 100 and retraining using a small training corpus 126, thus resulting in an equalized language model. Equalization training 104 uses an equalization loss function that attempts to equalize the associations of words that are nominally neutral (for example, “doctor”) with words that define a group (for example, “she” or “he”). Similarly, de-clustering training 106 involves incorporating a de-clustering loss 112 into the equalized language model or pretrained language model 100, and training using small training corpus 126. De-clustering training 106 uses a de-clustering loss function that attempts to mitigate word clustering that is stereotypically associated with a particular group, for example by de-clustering words observed as being frequently associated with female or male. Equalization training 104 and de-clustering training 106 produce a debiased language model 108 that includes not only MLM loss 102 that was included in pretrained language model 100, but that further includes equalization loss 110 and de-clustering loss 112. Debiased language model 108 can be used for natural language processing tasks such as fill-in-the-blank sentence completion. Debiased language model 108 can also be used as an encoder in conjunction with a decoder for text generation tasks, as will be described in turn. Additional details on equalization training 104 and de-clustering training 106 will be provided in turn with reference to FIG. 2 (schematic) and FIG. 3 (flowchart).

Using small training corpus 126 for equalization training 104 and de-clustering training 106 allows debiased language model 108 to be generated without incurring significant computational cost. In particular, small training corpus 126 is small compared to large training corpus 124 that is used for initial training of pretrained language model 100. Example corpora that can be used for small training corpus 126 include: a corpora of roughly one million news stories from the websites for news outlets CNN and the DailyMail (“CNN/DailyMail”), as described in Hermann et al., “Teaching Machines to Read and Comprehend”, Proceedings of the 28th International Conference on Neural Information Processing System, volume 1, pages 1693-1701 (December 2015); a corpora of roughly 28,000 articles extracted from the online encyclopedia Wikipedia (“WikiText-103”), as described in Merity et al., “Pointer Sentinel Mixture Models”, https://arxiv.org/abs/1609.07843 (2016); and the Brown University Standard Corpus of Present-Day American English (“Brown Corpus”), which is a general language corpus containing 500 samples of English, totaling roughly one million words, as described in Kucera et al., “Computational Analysis of Present-day American English”, Brown University Press (1967). These corpora are significantly smaller than large training corpus 124, often by one or more orders of magnitude. This allows pretrained language model 100 to be retrained, and debiased language model 108 to be generated, without incurring a substantial computational cost.

FIG. 1 also illustrates a transformer-based decoder 114 that can be used to complete a text generation task such as abstractive summarization. Abstractive summarization seeks to paraphrase long text with a short summary that preserves the most relevant information in the long text. Machine learning approaches to abstractive summarization conceptualize the task as a sequence-to-sequence problem, where an encoder maps a sequence of tokens in a source document x=[x₁, . . . xₙ] to a sequence of continuous representations z=[z₁, . . . zₙ], and a decoder then generates the target summary y=[y₁, . . . yₘ] token-by-token, in an auto-regressive manner, hence modeling the conditional probability as p(y₁, . . . yₘ|x₁, . . . xₙ). See Liu et al., “Text Summarization with Pretrained Encoders”, Proceedings of the 2019 Conference on Empirical Methods in Natural Language Processing and the 9th International Joint Conference on Natural Language Processing (EMNLP-IJCNLP), pages 3730-3740 (2019). Encoder-decoder models are often trained in an end-to-end supervised learning fashion to maximize a log likelihood objective. Thus transformer-based decoder 114 is understood as including a negative log likelihood loss 116 that penalizes solutions that do not capture the meaning, linguistic quality, and fluency of the source text.

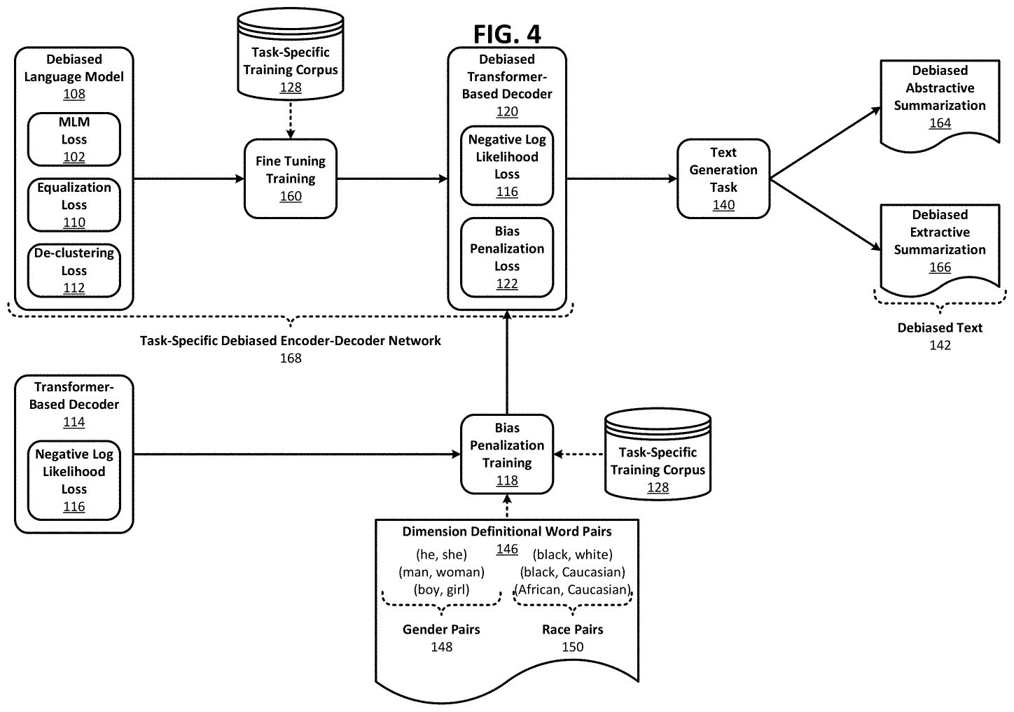

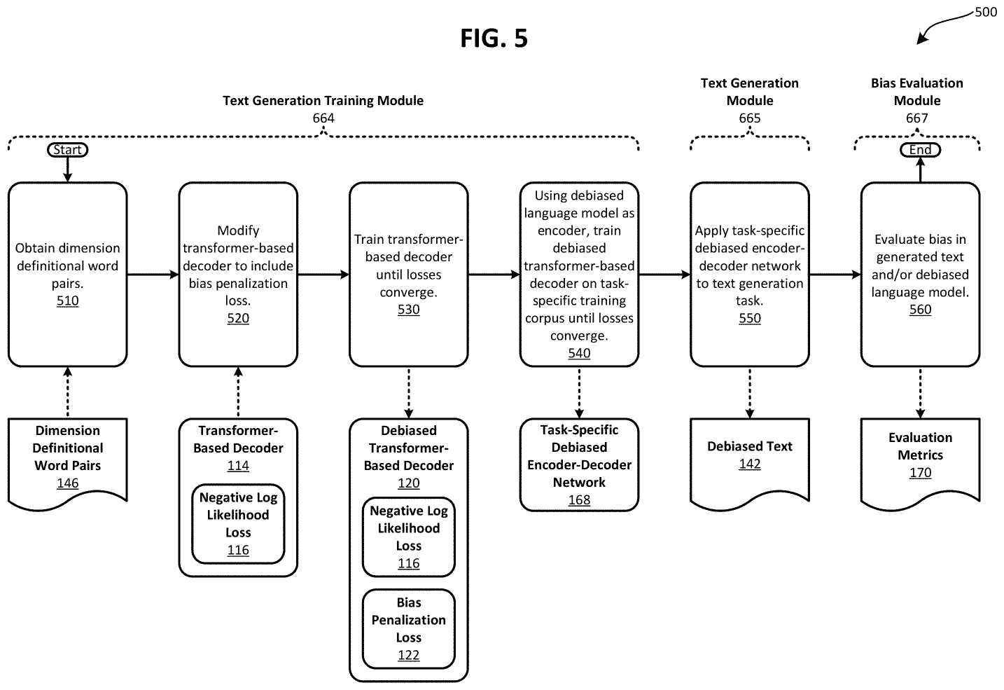

Transformer-based decoder 114 is trained using a task-specific training corpus 128, such as a long text passage that is to be summarized. This training is supplemented to further include bias penalization training 118 that incorporates a bias penalization loss 122 into transformer-based decoder 114. More specifically, bias penalization training 118 uses a bias penalization loss function that attempts to make the resulting debiased transformer-based decoder 120 choose words and/or sentences that are less objectionable or biased than words and/or sentences appearing in the task-specific training corpus 128. Debiased transformer-based decoder 120 includes both negative log likelihood loss 116 and bias penalization loss 122. Debiased transformer-based decoder 120 can be used in conjunction with a language model, such as pretrained language model 100 or debiased language model 108, to form an encoder-decoder architecture that is capable of performing a text generation task 140. The resulting debiased text 142 ideally preserves the meaning, linguistic quality, and fluency of the source text while mitigating the degree of social bias reflected therein. Additional details on bias penalization training 118 will be provided in turn with reference to FIG. 4 (schematic) and FIG. 5 (flowchart).

Model Debiasing

FIG. 2 is a block diagram that schematically illustrates an example framework for debiasing a language model through the use of an equalization loss function and a de-clustering loss function. FIG. 3 is a flowchart that illustrates an example method 300 for debiasing a language model using an equalization loss function and/or a de-clustering loss function. As can be seen, method 300 includes a number of phases and sub-processes, the sequence of which may vary from one embodiment to another. However, when considered in the aggregate, these phases and sub-processes subject pretrained language model 100 to equalization training 104 and de-clustering training 106 using small training corpus 126, thereby resulting in debiased language model 108 that includes equalization loss 110 and de-clustering loss 112.

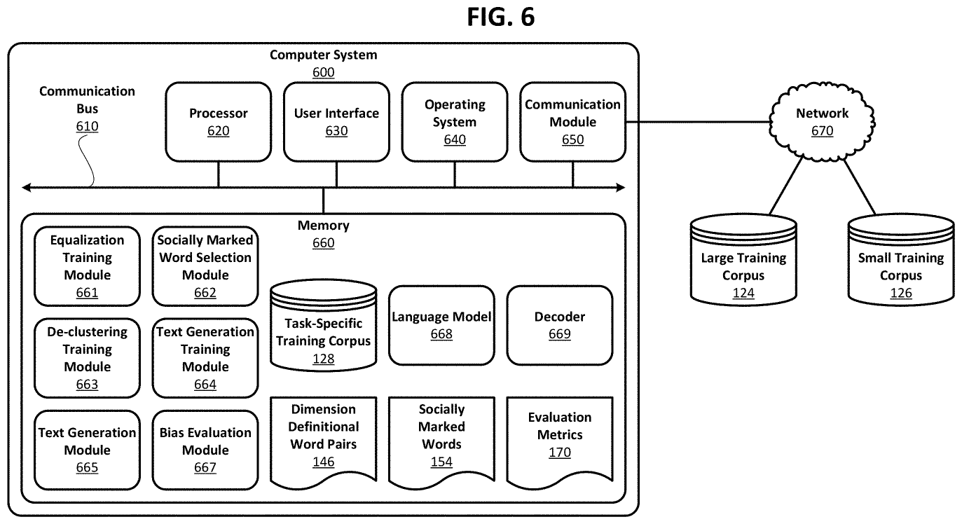

Method 300 can be implemented, for example, using the system architecture illustrated in FIG. 6 and described in turn. However, other system architectures can be used in other embodiments as will be apparent in light of this disclosure. To this end, the correlation of the various functionalities shown in FIGS. 2 and 3 to the specific components illustrated in FIG. 6 is not intended to imply any structural or use limitations. Rather other embodiments may include, for example, varying degrees of integration wherein multiple functionalities are effectively performed by one system or module. Thus other embodiments may have fewer or more modules depending on the granularity of implementation. Numerous variations and alternative configurations will be apparent in light of this disclosure.

As described above, in certain implementations a pretrained language model 100 undergoes equalization training 104 that uses an equalization loss function that attempts to equalize the associations of words that are nominally neutral (for example, “doctor”) with words that define a group (for example, “she” or “he”). As illustrated in FIG. 2, equalization training 104 takes as input pretrained language model 100, a list of dimension definitional word pairs 146, and small training corpus 126. Dimension definitional word pairs 146 consist of word tuples that define the groups with respect to which biases are to be mitigated or neutralized. For example, FIG. 2 illustrates a list of gender pairs 148 which might be used in an application where male and female biases are to be mitigated. FIG. 2 also illustrates an alternative list of race pairs 150 which might be used in an application where African American and Caucasian biases are to be mitigated. Biases with respect to additional or alternative demographic groups may be mitigated in other implementations, and the list of dimension definitional word pairs 146 would be modified accordingly. In general, it will be appreciated that the particular dimension definitional word pairs 146 illustrated in FIG. 2 are provided for example only, and additional, alternative, or fewer word pairs may be used in other implementations.

As the name implies, dimension definitional word pairs 146 include words that expressly define a particular group with respect to which biases are to be mitigated. For example, where gender debiasing is targeted, and where female and male are the gender groups which are to be neutralized, dimension definitional word pairs 146 might include tuples such as {she, he}, {woman, man}, {herself, himself}, {sister, brother}, and {girl, boy}, among others. Or, where race debiasing is targeted, and where African American and Caucasian are the racial groups which are to be neutralized, dimension definitional word pairs 146 might include {Black, white}, {Black, Caucasian}, or {African, Caucasian}. Words other than the words appearing in dimensional definitional word pairs 146 are referred to as “neutral” words.

In one implementation, method 300 is initiated when an equalization training module 661 obtains dimension definitional word pairs 146. See reference numeral 310 in FIG. 3. In one implementation dimension definitional word pairs 146 are defined in advance and are retrieved from an appropriate digital storage location, such as from random access memory provided at a local computer, or from a cloud-based storage location. For example, in one application appropriate dimension definitional word pairs 146 are retrieved in response to user input that defines the type of debiasing that is to be performed (such as gender or race debiasing). In alternative implementations dimension definitional word pairs 146 are received from a user interface based on user input, thereby allowing a user to uniquely specify the dimension definitional word pairs 146 based on the needs of a particular text generation task.

During equalization training 104, pretrained language model 100 is further trained on small training corpus 126. More specifically, given a sequence of input words (also referred to as “tokens”) from small training corpus 126, pretrained language model 100 will randomly mask a certain percentage (for example, 15%) of the tokens and learn to predict the masked tokens based on context to the left and right of each masked token. The MLM cross-entropy loss function for predicting the masked tokens in pretrained language model 100 can be expressed as

$$MLM Loss = - \frac{1}{N} {\sum }_{n = 1}^{N} {\sum }_{v = 1}^{V} {y}_{n , v} log {\hat{y}}_{n , v} . \qquad ( 1 )$$

Here N is the total number of masked tokens, V is the size of the vocabulary, y_{n,v}=1 for the actual token, and ŷ_{n,v} is the prediction score of token v.

Equalization training 104 incorporates an equalization loss 110 into pretrained language model 100 and then retrains the model using small training corpus 126. In one implementation this involves equalization training module 661 modifying pretrained language model 100 to include equalization loss 110 (see reference numeral 320 in FIG. 3), and then training the model until losses converge (see reference numeral 330 in FIG. 3). This results in an equalized language model 144. Equalization training 104 uses an equalization loss function that attempts to equalize the associations of neutral words (for example, “doctor”) with words that define a group (for example, “she” or “he”). In one implementation, the equalization loss function is expressed as

$$Equalization Loss = {λ}_{e q} \frac{1}{K} {\sum }_{k = 1}^{K} \vert log ( \frac{P ( D G {A}_{k} )}{P ( D G {B}_{k} )} ) \vert . \qquad ( 2 )$$

Here λ_{eq} is a weight assigned to the equalization loss, λ_{eq}≥0. In addition, K is the total number of pairs of dimension definitional word pairs 146, P(DGAₖ) is a probability associated with the first word in the kth dimension definitional word pair, and P(DGBₖ) is a probability associated with the second word in the kth dimension definitional word pair.

The goal of equalization training 104 is to equalize, to the greatest extent possible, the chances that either of the words in a particular dimension definitional word pair appear at a given point in generated text. For example, in the sentence, “[X] is a doctor”, the probabilities of [X] being equal to “He” and “She” would, ideally, be equal. Thus equalization loss 110 seeks to equalize the probability associated with the first word in the kth dimension definitional word pair (that is, P(DGAₖ)) and the probability associated with the second word in the kth dimension definitional word pair (that is, P(DGBₖ)). According to Equation (2), when these probabilities are equal, the logarithm of their ratio is zero (log(1)=0) and there is no contribution to equalization loss 110. On the other hand, a model that predicts significantly different probabilities for the two words in a particular dimension definitional word pair suggests that the predicted solution reflects a social bias. For example, a model that predicts a significantly higher likelihood of generating the sentence “He is a doctor” than “She is a doctor” appears to reflect a gender bias. Such solution would have a large contribution to equalization loss 110, and would thus be penalized in equalization training 104. In general, equalizing the associations between neutral words and the dimension definitional word pairs 146 is considered to be an approximation of equalizing associations with the groups to be neutralized.

Even after equalization training 104, equalized language model 144 may still generate implicit word clusters that are stereotypically associated with one of the given dimensions (for example, one of the gender dimensions or one of the race dimensions). For instance, even after equalization training 104 to neutralize the gender dimension, words that are nominally gender-neutral but that are nevertheless stereotypically associated with male or female are still observed to cluster together. To provide a more specific example, consider words such as “delicate” and “protége”, which are nominally gender-neutral but which still have strong gender associations to female and male, respectively. Equalized language model 144 will still closely associate “delicate” and “protége” with other words that stereotypically have female and male connotations, respectively. These associations are reflected in how equalized language model 144 arranges neighboring words. Notably, this clustering effect is still observed in equalized language model 144 which has been subjected to equalization training 104.

In the case of gender, nominally neutral words like “pink”, “blonde”, “beautiful”, “nurse”, “receptionist”, and “fragile” are observed to cluster together relatively closer to other words having a female connotation, thus evincing a social bias toward female for these words. Likewise, nominally neutral words like “entrepreneur”, “buddy”, “aspiring”, “arrogant”, and “bodyguard” are observed to cluster together relatively closer to other words having a male connotation, thus evincing a social bias toward male for these words. These gender associations are learned from large training corpus 124 which is used to train a language model, and in particular, the training process incorporates these gender associations into pretrained language model 100. After subjecting pretrained language model 100 to equalization training 104, bias in these words often cannot be observed directly. For example, equalization training 104 may associate the word “nurse” roughly equally with definitional words such as “he” and “she”. But bias may still be manifested if “nurse” is closely associated with other female-connotated words such as “receptionist”, “pink”, and “fragile”. These associations can be perceived as unwanted and sometimes even objectionable, and therefore using a language model that tends to cluster words in this way poses a risk of perpetuating social biases and/or offending certain communities.

Given the foregoing, in certain implementations equalized language model 144 undergoes de-clustering training 106 that uses a de-clustering loss function that attempts to mitigate these word clusters and the corresponding associations that are stereotypically associated with a particular group. As illustrated in FIG. 2, in one implementation de-clustering training 106 takes as input equalized language model 144, a list of socially marked words 154, and small training corpus 126. In an alternative implementation equalization training 104 is omitted and de-clustering training takes as input pretrained language model 100 instead of equalized language model 144. Socially marked words 154 are words that are nominally neutral, but for which social bias may nevertheless be manifested as a result of the word still having a close association with other words that carry some residual association with a particular group.

In some implementations the list of socially marked words 154 is predefined or otherwise coded in advance. However in other implementations the list of socially marked words 154 is automatically generated through a process of social word selection 152. In such implementations a socially marked word selection module 662 automatically identifies socially marked words 154 using small training corpus 126. See reference numeral 340 in FIG. 3. In this case, the list of socially marked words 154 is generated by first extracting, from pretrained language model 100, contextual representations of the words comprising small training corpus 126. In an implementation where pretrained language model 100 is BERT, the contextual representations are obtained using the sum of the vectors from the last four layers of the model, although other methods of extraction can be used in other implementations. In one implementation small training corpus 126 is the Brown Corpus, referenced above, because the Brown Corpus advantageously includes words in context of a diverse range of topics, thus avoiding ambiguity that may be introduced when words are seen without any context.

Once the word representations are obtained from pretrained language model 100, for each word an average of all representations of that word is calculated. The word representations can then be projected onto an axis that represents a differential between two groups defined by the dimension of interest. For example, in the case of gender, words with the highest projections on a she-he axis and words with the highest projections on a he-she axis are identified. Likewise, for race, words with the highest projections on a slave-manager axis and words with the highest projections on a manager-slave axis are identified. The words with the highest projections on a differential axis represent the words that are most likely to be clustered with other words that are closely associated with a particular group. In one implementation, the words with the highest projections are included in the list of socially marked words 154.

FIG. 2 illustrates example lists of socially marked words 154 extracted from the Brown Corpus for the gender and race dimensions. For a given dimension (for example, gender), each of socially marked words 154 is closely associated with one of the groups (for example, female or male) defined by the given dimension. These two groups are generically referred to herein as Group A and Group B. In an implementation wherein socially marked gender words 156 are extracted from the Brown Corpus, gender words 156 having the highest projections on the she-he and he-she axes include “nurse”, “fragile”, and “pink” in Group A; and “arrogant”, “police”, and “smoking” in Group B. Likewise, in an implementation wherein socially marked race words 158 are extracted from the Brown Corpus, race words 158 having the highest projections on the slave-manager and manager-slave axes include “slavery”, “inequality”, and “curse” in Group A; and “wealthy”, “whites”, and “master” in Group B. It will be appreciated that these lists of socially marked words are provided by way of example only, and other lists of additional, alternative, or fewer words may be used in other implementations. For example, using a different small training corpus 126 will likely result in different sets of socially marked words 154.

Referring still to FIG. 2, during de-clustering training 106, equalized language model 144 is further trained on small training corpus 126. De-clustering training 106 further incorporates de-clustering loss 112 into equalized language model 144 or pretrained language model 100 and retraining using small training corpus 126. In one implementation this involves a de-clustering training module 663 modifying equalized language model 144 to include de-clustering loss 112 (see reference numeral 350 in FIG. 3), and then training the model until losses converge (see reference numeral 360 in FIG. 3). This results in a debiased language model 108 that includes MLM loss 102, de-clustering loss 112, and optionally, equalization loss 110. De-clustering training 106 uses a de-clustering loss function that attempts to equalize, at a particular point in generated text, the percentage of nearby socially marked words in Groups A and B. In one implementation, the de-clustering loss function is expressed as

$$De \text{-} clustering Loss = {λ}_{d c} \vert log \frac{{\sum }_{i = 1}^{A} P ( S G {A}_{i} )}{{\sum }_{i = 1}^{B} P ( S G {B}_{i} )} \vert . \qquad ( 3 )$$

Here λ_{dc} is a weight assigned to the de-clustering loss, λ_{dc}≥0. In addition, A and B are the total number of socially marked words 154 in Groups A and B, respectively; P(SGAᵢ) is a probability of the ith socially marked word in Group A occurring at a particular point in generated text; and P(SGBᵢ) is a probability of the ith socially marked word in Group B occurring at the particular point in generated text.

The goal of de-clustering training 106 is to equalize, to the greatest extent possible, the percentage of socially marked words in Groups A and B at any given point in generated text. Doing so will de-cluster the implicit clusters that may still exist even after equalization training 104, as explained above. Where the aggregate probabilities of socially marked words in Group A (that is, Σᵢ₌₁^{A} P(SGAᵢ)) and the aggregate probabilities of socially marked words in Group B (that is, Σᵢ₌₁^{B} P(SGBᵢ)) are equal, the logarithm of the ratio of aggregate probabilities is zero (log (1)=0) and there is no contribution to de-clustering loss 112. On the other hand, a model that predicts significantly different aggregate probabilities between Groups A and B suggests that the predicted solution reflects a social bias. For example, a model that generates text having several socially marked words from Group A but few socially marked words from Group B will appear to reflect a bias toward or against Group A. Such solution would have a large contribution to de-clustering loss 112, and thus would be penalized in de-clustering training 106. In general, equalizing the use of socially marked words associated with different groups is considered to favor model solutions that de-cluster implicit word clusters.

Referring again to FIG. 2, equalization training 104 and de-clustering training 106 result in debiased language model 108 that includes both equalization loss 110 and de-clustering loss 112. In an alternative implementation wherein equalization training 104 is omitted, equalization loss 110 is omitted from debiased language model 108. Debiasing pretrained language model 100 involves further training using only small training corpus 126, and thus such further training does not incur a substantial computational cost as compared to the computational cost associated with training using large training corpus 124. The resulting debiased language model 108 can be used for natural language processing tasks such as fill-in-the-blank sentence completion. Such tasks are completed based on the word associations defined by the trained and debiased language model 108. These word associations can be graphically represented by a scatter diagram that illustrates spatial relationships of selected words for a given language model.

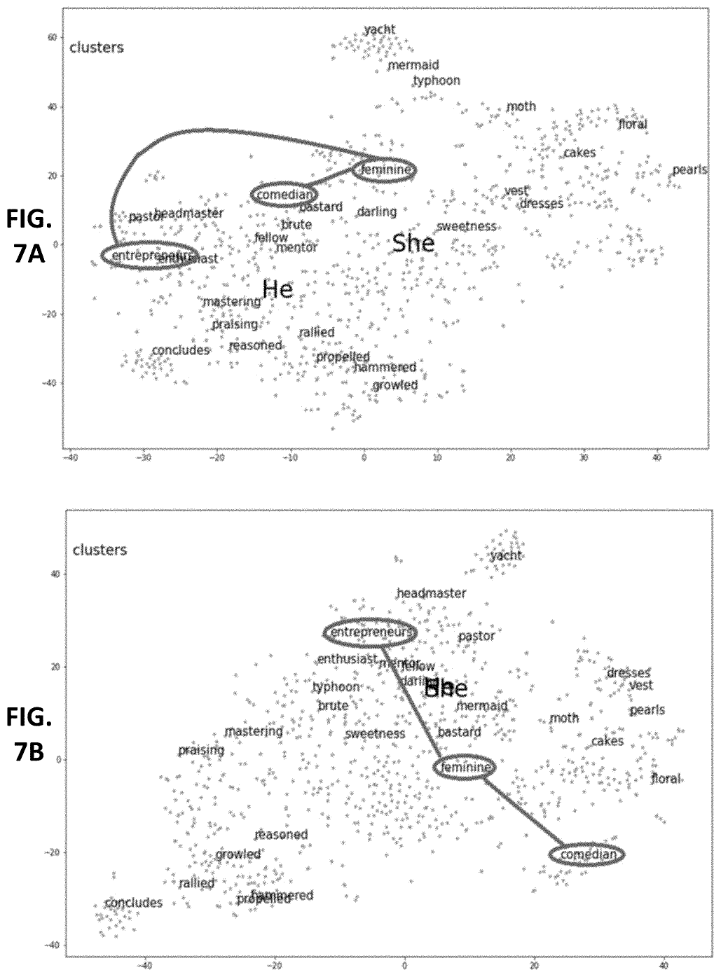

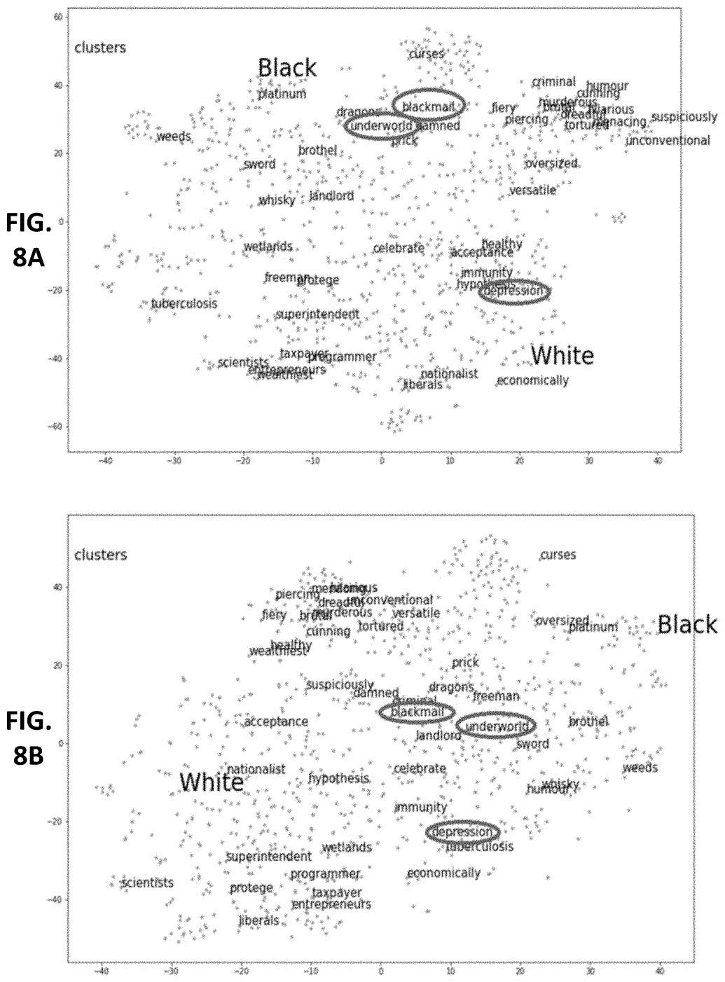

For example, FIG. 7A is a word embedding scatter diagram illustrating spatial relationships of selected words having gender associations as defined by a language model that does not include debiasing loss functions, such as pretrained language model 100. On the other hand, FIG. 7B is a word embedding scatter diagram illustrating spatial relationships of selected words having gender associations as defined by a debiased language model that includes debiasing loss functions, such as debiased language model 108. FIG. 7A illustrates words such as “entrepreneur”, “mentor”, and “reasoned” being more closely associated with each other, while words such as “sweetness”, “darling”, and “feminine” are likewise more closely associated with each other. The clustering of words evident in FIG. 7A has been mitigated in the word associations shown in FIG. 7B. Similarly, FIG. 8A is a word embedding scatter diagram illustrating spatial relationships of selected words having racial associations as defined by a language model that does not include debiasing loss functions, while FIG. 8B is a word embedding scatter diagram illustrating spatial relationships of selected words having racial associations as defined by a debiased language model that includes debiasing loss functions. Similar effects can be seen in the clustering of words as shown in FIGS. 8A and 8B.

Decoder Debiasing

FIG. 4 is a block diagram that schematically illustrates an example framework for debiasing a language decoder through the use of a bias penalization loss function, and for using the debiased language decoder to complete a text generation task. FIG. 5 is a flowchart that illustrates an example method 500 for debiasing a language decoder using a bias penalization loss function, and for using the debiased language decoder to complete a text generation task. As can be seen, method 500 includes a number of phases and sub-processes, the sequence of which may vary from one embodiment to another. However, when considered in the aggregate, these phases and sub-processes subject transformer-based decoder 114 to bias penalization training 118 using task-specific training corpus 128, thereby resulting in debiased transformer-based decoder 120 that includes bias penalization loss 122.

Method 500 can be implemented, for example, using the system architecture illustrated in FIG. 6 and described in turn. However, other system architectures can be used in other embodiments as will be apparent in light of this disclosure. To this end, the correlation of the various functionalities shown in FIGS. 4 and 5 to the specific components illustrated in FIG. 6 is not intended to imply any structural or use limitations. Rather other embodiments may include, for example, varying degrees of integration wherein multiple functionalities are effectively performed by one system or module. Thus other embodiments may have fewer or more modules depending on the granularity of implementation. Numerous variations and alternative configurations will be apparent in light of this disclosure.

As described above, transformer-based decoder 114 undergoes bias penalization training 118 that uses a bias penalization loss function that attempts to penalize the use of words and/or sentences in generated text that are more likely to be objectionable or biased. This training results in debiased transformer-based decoder 120 that includes both negative log likelihood loss 116 and bias penalization loss 122. Debiased language model 108 can be used as an encoder along with debiased transformer-based decoder 120 to form an encoder-decoder summarizer model that can be used for text generation tasks 140 such as abstractive summarization. As will be described in turn, when the encoder-decoder summarizer model is trained using task-specific training corpus 128, it forms a task-specific debiased encoder-decoder network 168.

Debiasing an encoder-decoder framework that is used for summarization is particularly challenging since the generated output summary must be constrained on the given text that is to be summarized. In many applications the given text will contain explicitly objectionable, offensive, or otherwise unwanted content. Thus, even with a debiasing objective in the encoder, such as described above with respect to equalization loss 110 and de-clustering loss 112, the text generated by an encoder-decoder framework may still contain some amount of biased content. To mitigate the influence that this unwanted content has on the generated text, transformer based decoder 114 is modified to include a bias penalizing objective when it is retrained on task-specific training corpus 128.

As illustrated in FIG. 4, this bias penalization training 118 takes as input transformer-based decoder 114, a list of dimension definitional word pairs 146, and task-specific training corpus 128. Bias penalizing training 118 produces a debiased transformer-based decoder 120 that includes both negative log likelihood loss 116 and bias penalization loss 122. In certain implementations debiased language model 108 is used as an encoder along with debiased transformer-based decoder 120 to form an encoder-decoder summarizer model that can be subjected to fine tuning training 160 using task-specific training corpus 128. In other implementations debiased language model 108 is used as an encoder along with pretrained language model 100 that is subjected to fine tuning training 160. In either case, this further task-specific training results in task-specific debiased encoder-decoder network 168 which can be used to complete text generation tasks 140 such as abstractive summarization. Text generation tasks are understood as broadly encompassing tasks that generate debiased text 142, including but not limited to summarization tasks. In some implementations a summarization task produces a debiased abstractive summarization 164 wherein summary sentences having mitigated bias are generated based on task-specific training corpus 128. In other implementations a summarization task produces a debiased extractive summarization 166 wherein summary sentences having low levels of bias are extracted from task-specific training corpus 128.

As described above with respect to model debiasing, dimension definitional word pairs 146 consist of word tuples that define the groups with respect to which biases are to be mitigated or neutralized. For example, where gender debiasing is targeted, and where female and male are the gender groups which are to be neutralized, dimension definitional word pairs 146 might include {she, he}, {woman, man}, {herself, himself}, {sister, brother}, and {girl, boy}, among others. Or, where race debiasing is targeted, and where African American and Caucasian are the racial groups which are to be neutralized, dimension definitional word pairs 146 might include {Black, white}, {Black, Caucasian}, or {African, Caucasian}. In some embodiments the same list of dimension definitional word pairs 146 are used for both model debiasing and decoder debiasing.

In one implementation, method 500 is initiated when a text generation training module 664 obtains dimension definitional word pairs 146. See reference numeral 510 in FIG. 5. In one implementation dimension definitional word pairs 146 are defined in advance and are retrieved from an appropriate digital storage location, such as from random access memory provided at a local computer, or from a cloud-based storage location. For example, in one application appropriate dimension definitional word pairs 146 are retrieved in response to user input that defines the type of debiasing that is to be performed (such as gender or race debiasing). In alternative implementations dimension definitional word pairs 146 are received from a user interface based on user input, thereby allowing a user to uniquely specify the dimension definitional word pairs 146 based on the needs of a particular text generation task.

Bias penalization training 118 incorporates a bias penalization loss 122 into transformer-based decoder 114 and then trains the decoder using task-specific training corpus 128. In one implementation this involves text generation training module 664 modifying transformer-based decoder 114 to include bias penalization loss 122 (see reference numeral 520 in FIG. 5), and then training the decoder until losses converge (see reference numeral 530 in FIG. 5). This results in debiased transformer-based decoder 120. Bias penalization training 118 uses a bias penalization loss function that attempts to make debiased transformer-based decoder 120 choose words and/or sentences that are less objectionable or biased than words and/or sentences appearing in the task-specific training corpus 128. In one implementation, the bias penalization loss function is expressed as:

$$Bias Penalization Loss = {λ}_{b p} {\sum }_{i = 1}^{W} ( {e}^{{b}_{i}} \times P ( {W}_{i} ) ) . \qquad ( 4 )$$

Here λ_{bp} is a weight assigned to the bias penalization loss, λ_{bp}≥0. In addition, W is the set of all adjectives and adverbs in the vocabulary, bᵢ is the bias score of adjective/adverb Wᵢ, and P(Wᵢ) is the probability of adjective/adverb Wᵢ occurring at a particular point in generated text. In implementations where bias scores are large, such as bᵢ≥3, (1+bᵢ) can be used in place of e^{b}^{ᵢ} in Equation (4); this may occur in applications where race debiasing is performed, as contrasted with gender debiasing.

The bias score bᵢ of adjective/adverb Wᵢ is expressed as:

$${b}_{i} = \frac{1}{K} {\sum }_{j = 1}^{K} \vert log ( \frac{P ( D G {A}_{j} , {W}_{i} )}{P ( D G {B}_{j} , {W}_{i} )} ) \vert . \qquad ( 5 )$$

Here K is the total number of pairs of dimension definitional word pairs 146; Wᵢ is the ith adjective/adverb for which the bias score bᵢ is computed; P(DGAⱼ, Wᵢ) is the probability that the first word in the jth dimension definitional word pair cooccurs with adjective/adverb Wᵢ and P(DGBⱼ, Wᵢ) is the probability that the second word in the jth dimension definitional word pair cooccurs with adjective/adverb Wᵢ. As used herein, two words are understood to “cooccur” when they are within n words of each other in generated text, where n is referred to as a context window. In one implementation, context window n=10 words, although other context windows can be used in other implementations, such as n=2, 5, 8, 9, 11, 12, 15, 18, or 20 words. Other values of n can be used in other implementations.

The goal of bias penalization training 118 is to equalize, to the greatest extent possible, the use of particular adjectives and adverbs in conjunction with dimension definitional words such as {she, he}, {woman, man}, {Black, white}, or {Black, Caucasian}. For example, where two corresponding dimension definitional words (for example, “she” and “he”) are equally likely to cooccur with a particular adjective/adverb, the logarithm of their ratio is zero (log(1)=0), and there is no contribution to the bias score for the particular adjective/adverb. On the other hand, a model that predicts that one of the two corresponding dimension definitional words is much more (or less) likely to cooccur with a particular adjective/adverb suggests that the predicted solution reflects a social bias. Such solution would have a large contribution to the bias score for that adjective/adverb, and thus would be penalized in bias penalization training 118. For example, if the word “delicate” has a relatively high cooccurrence with “she”, then “delicate” will have a relatively high bias score. Likewise if the word “arrogant” has a relatively high cooccurrence with “he” then “arrogant” will have a relatively high bias score. In general, equalizing how adjectives/adverbs are used with dimension definitional words produces words and/or sentences that are less likely to be objectionable and/or biased, but that still convey the highlights, linguistic quality, and fluency of task-specific training corpus 128.

Debiased language model 108 can be used as an encoder along with debiased transformer-based decoder 120 to form an encoder-decoder summarizer model that can be subjected to fine tuning training 160 using task-specific training corpus 128. Thus in one implementation text generation training module 664 uses debiased language model 108 as an encoder to train debiased transformer-based decoder 120 on task-specific training corpus 128 until losses converge. See reference numeral 540 in FIG. 5. This further task-specific training results in task-specific debiased encoder-decoder network 168 which can be used to complete text generation tasks 140 such as abstractive summarization. In particular, text generation module 665 can apply the resulting task-specific debiased encoder-decoder network 168 to text generation tasks 140. See reference numeral 550 in FIG. 5. In one application, completing text generation task 140 produces debiased text 142, such as a debiased abstractive summarization 164 based on task-specific training corpus 128. This could be used, for example, to generate new sentences that form a short summary of a longer article, wherein the summary sentences have mitigated levels of social bias. It could also be used to automatically generate a subject line for a user-compiled email message.

Task-specific debiased encoder-decoder network 168 is also capable of generating debiased extractive summarization 166 by extracting one or more sentences from task-specific training corpus 128. In such case the extracted sentences ideally both capture the most relevant highlights of the entire task-specific training corpus 128, but also reflect low levels of social bias. A debiased approach to extractive summarization will therefore incorporate debiasing heuristics in the process of selecting sentences based on their semantic relevance. This can be approached as a classification task wherein debiased language model 108 is used as an encoder, with an additional classification layer applied to classify each sentence in task-specific training corpus 128 to be present or not in debiased extractive summarization 166. In certain implementations such a model is trained with binary classification entropy with a sigmoid classifier as a final output layer. The sigmoid represents the probability distribution of each sentence being included or excluded from the summary. The debiasing component is incorporated at inference time during sentence selection, wherein the sentences included in task-specific training corpus 128 are ranked and selected according to a sentence score S that equals the difference between the sigmoid score from the final layer (σ) and the bias score of the sentence (bₛ). That is, S=σ−bₛ. Here bₛ is equal to the constrained co-occurrence score of a given sentence, as provided by Equation (6), below. Sentences are selected for inclusion in debiased extractive summarization 166 that are of high relevance (as reflected by σ) and that contain minimum objectionable or offensive content (as reflected by bₛ).

In some cases it may be desired to evaluate the extent to which bias has been mitigated using the techniques disclosed herein. For example, a bias evaluation module 667 can be configured to evaluate bias in debiased text 142 and/or in debiased language model 108. See reference numeral 560 in FIG. 5. A wide range of bias evaluation metrics 170 can be used in this regard. One example bias evaluation metric 170 that can be used to quantify bias in generated text is the constrained co-occurrence score CCO, which can be expressed as:

$$CCO ( text ) = \frac{1}{N} {\sum }_{w ∈ N} \vert log ( \frac{{\sum }_{a ∈ A} c ( w , a )}{{\sum }_{b ∈ B} c ( w , b )} ) \vert . \qquad ( 6 )$$

Here N is the set of adjectives and adverbs in text, A is the set of dimension definitional word pairs that define a first group (for example, the set {she, woman, herself, sister, girl}), B is the set of dimension definitional word pairs that define a second group (for example, the set {he, man, himself, brother, boy}), c(w, d) gives the number of cooccurrences of word w with words of dimension d in its context. As used herein, two words are understood to “cooccur” when they are within a n words of each other in generated text, where n is referred to as a context window. In one implementation, context window n=10 words, although other context windows can be used in other implementations, such as n=2, 5, 8, 9, 11, 12, 15, 18, or 20 words. Other values of n can be used in other implementations. According to this metric, CCO(text)∈{0, ∞}, with higher values indicating more bias present in text. Additional details regarding other bias evaluation metrics will be disclosed in conjunction with the experimental results described in turn.

System Architecture

FIG. 6 is a block diagram that illustrates an example computing environment configured for training and using a debiased language model in a way that mitigates the degree of social bias reflected in text generated using the model. More specifically, the computing environment illustrated in FIG. 6 includes a computer system 600, a network 670, large training corpus 124, and small training corpus 126. Computer system 600 may comprise, for example, one or more devices selected from a desktop computer, a laptop computer, a workstation, a tablet computer, a smartphone, a handheld computer, a set-top box, an enterprise class server, or any other such computing device. A combination of different devices may be used in certain embodiments. In general, computer system 600 will be understood as including software configured to implement the various functionalities disclosed herein, as well as hardware that enables such implementation. Examples of enabling hardware include a communication bus 610, a processor 620, a communication module 650, and a memory resource 660. Examples of implementing software include a user interface 630, an operating system 640, equalization training module 661, socially marked word selection module 662, de-clustering training module 663, text generation training module 664, text generation module 665, and bias evaluation module 667. Memory resource 660 can also be used to store a language model 668, a decoder 669, task-specific training corpus 128, dimension definitional word pairs 146, socially marked words 154, and evaluation metrics 170. In certain embodiments memory resources 660 is also used to store large training corpus 124 and/or small training corpus 126, thus allowing the techniques disclosed herein to be performed in standalone fashion, without regard to network accessibility. Depending on the granularity of implementation, computer system 600 may include additional, alternative, or fewer hardware and software components in other embodiments. The present disclosure therefore should not be understood as being limited to the particular architecture and components illustrated in FIG. 6.

Depending on the particular type of device used for implementation, computer system 600 is optionally coupled to, or otherwise implemented in conjunction with, one or more peripheral hardware components. Examples of peripheral hardware components include a display, a textual input device (such as a keyboard), and a pointer-based input device (such as a mouse). One or more other input/output devices, such as a touch sensitive display, a speaker, a printer, or a microphone, can be used in other embodiments. For example, in a particular alternative embodiment wherein computer system 600 is implemented in the form of a tablet computer, certain functionality described herein is provided by a touch sensitive surface and a camera that form part of the tablet computer.

As noted above, in certain implementations computer system 600 is coupled to network 670 to allow for communications with other computing devices or resources, such as large training corpus 124 and small training corpus 126. Network 670 may be a local area network (such as a home-based or office network), a wide area network (such as the Internet), a peer-to-peer network (such as a Bluetooth connection), or a combination of such networks, whether public, private, or both. For example, in certain embodiments at least a portion of the functionality associated with network 670 is provided by a cellular data network, thereby making it easier for users of smartphones, tablet computers, and other portable devices to leverage networked resources. In general, it should be appreciated that communications amongst the various entities and resources described herein may occur via wired and/or wireless connections.

In alternative embodiments large training corpus 124 and small training corpus 126 are stored in memory resource 660, thus enabling local implementation of the techniques disclosed herein. In still other alternative embodiments other resources are accessible via network 670, including for example task-specific training corpus 128, language model 668, decoder 669, dimension definitional word pairs 146, and socially marked words 154. For example, language model 668 may comprise one or more of pretrained language model 100, equalized language model 144, and debiased language model 108. Likewise, decoder 669 may comprise one or more of transformer-based decoder 114 and debiased transformer-based decoder 120. In still other alternative embodiments one or more of the executable computing modules disclosed herein are accessible via network 670, thus allowing the techniques disclosed herein to be implemented on a lightweight device that is capable of leveraging networked computing resources such as networked processors or processing units.

Communication bus 610 allows for inter- and intra-device communications using communication module 650. Processor 620 can be any suitable processor, and may include one or more coprocessors or controllers, such as an audio processor or a graphics processing unit, to assist in control and processing operations associated with computer system 600. Communication module 650 can be any appropriate network chip or chipset which allows for wired or wireless connection to other components of computer system 600, to peripheral hardware components (if any), and to network 670, thereby enabling computer system 600 to communicate with other local and remote computer systems, services, and resources, examples of which include large training corpus 124 and small training corpus 126. Memory resource 660 can be implemented using any suitable type of digital storage, such as one or more of a disc drive, a flash memory device, or a random access memory device. In certain embodiments memory resource 660 is a non-transitory computer readable medium used to store program instructions that, when executed using processor 620, cause operations associated with one or more of the various computing modules disclosed herein to be invoked.

User interface 630 can implemented as any suitable user interface capable of receiving user instructions and displaying information generated by the debiasing framework disclosed herein. For example, in one implementation user interface 630 is a graphical user interface capable of receiving user input that identifies one or more of: task-specific training corpus 128; small training corpus 126; the groups with respect to which bias is to be mitigated; dimension definitional word pairs 146; socially marked word pairs 154; and one or more of configuration settings such as equalization loss weight λ_{eq}, de-clustering loss weight dc, bias penalization loss weight λ_{bp}, and cooccurrence context window n. Operating system 640 may comprise any suitable operating system, such as Android™ (Google Inc., Mountain View, Calif.), Windows® (Microsoft Corp., Redmond, Wash.), or OS X® (Apple Inc., Cupertino, Calif.). As will be appreciated in light of this disclosure, the techniques provided herein can be implemented without regard to the particular operating system provided in conjunction with computer system 600, and therefore may also be implemented using any suitable existing or subsequently developed platform.

In certain implementations memory resource 660 has stored therein one or more computing modules comprising instructions that, when executed using processor 620, cause certain of the functionalities disclosed herein to be implemented. In other implementations the computing modules may be at least partially implemented by hardware circuitry and/or firmware stored, for example, in a nonvolatile memory resource. For example, in certain implementations equalization training module 661 comprises instructions that, when executed, cause processor 620 to obtain dimension definitional word pairs 146, modify pretrained language model 110 to include equalization loss 110, and train the modified language model until losses converge. In certain implementations, socially marked word selection module 662 comprises instructions that, when executed, cause processor 620 to identify and extract socially marked words from small training corpus 126. In certain implementations, de-clustering training module 663 comprises instructions that, when executed, cause processor 620 to modify equalized language model 144 to include de-clustering loss 112, and to further train the modified language model until losses converge. Certain implementations of the functionality provided by equalization training module 661, socially marked word selection module 662, and de-clustering training module 663 are described above with respect to FIGS. 2 and 3.

Likewise, in certain implementations text generation training module 664 comprises instructions that, when executed, cause processor 620 to obtain dimension definitional word pairs 146, modify transformer-based decoder 114 to include bias penalization loss 122, train the decoder until losses converge, and train debiased transformer-based decoder 120 on task-specific training corpus 128. In certain implementations text generation module 665 comprises instructions that, when executed, cause processor 620 to apply task-specific debiased encoder-decoder network 168 to text generation task 140. In certain implementations bias evaluation module 667 comprises instructions that, when executed, cause processor 620 to evaluate the degree of social bias reflected in a language model or in text generated by the language model. Certain implementations of the functionality provided by text generation training module 664, text generation module 665, and bias evaluation module 667 are described above with respect to FIGS. 4 and 5.

The embodiments described herein can be implemented in various forms of hardware, software, firmware, or special purpose processors. For example, in one embodiment a non-transitory computer readable medium has instructions encoded thereon that, when executed by one or more processors, cause aspects of the bias mitigation techniques disclosed herein to be implemented. The instructions can be encoded using any suitable programming language, such as C, C++, object-oriented C, Java, JavaScript, Visual Basic .NET, BASIC, Scala, or alternatively, using custom or proprietary instruction sets. Such instructions can be provided in the form of one or more computer software applications or applets that are tangibly embodied on a memory device, and that can be executed by a computer having any suitable architecture. In one embodiment the system can be hosted on a given website and implemented, for example, using JavaScript or another suitable browser-based technology.

The functionalities disclosed herein can optionally be incorporated into a variety of different software applications, including software applications that use a language model to complete text generation tasks. Examples of such software applications include an email software application that automatically generates a subject line for a drafted email, a word processor software application that automatically summarizes a document, and a document reader software application that automatically generates an abstractive or extractive summary of a viewed document. The computer software applications disclosed herein may include a number of different modules, sub-modules, or other components of distinct functionality, and can provide input to, or receive information from, still other components and services. These modules can be used, for example, to communicate with input/output devices such as a display screen, a touch sensitive surface, a printer, or any other suitable input/output device. Other components and functionality not reflected in the illustrations will be apparent in light of this disclosure, and it will be appreciated that the present disclosure is not limited to any particular hardware or software configuration. Thus in other embodiments the components illustrated in FIG. 6 may include additional, fewer, or other subcomponents.

The aforementioned memory resource 660 may be any suitable non-transitory computer readable medium for storing digital information, such as a hard drive, a server, a flash memory, random access memory, or any suitable combination of the foregoing. In alternative embodiments, the computers and modules disclosed herein can be implemented with hardware, including gate level logic such as a field-programmable gate array, or alternatively, a purpose-built semiconductor such as an application-specific integrated circuit. Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used in this regard, and that the present disclosure is not limited to any particular system architecture.

Evaluation Metrics and Experimental Results

The various bias mitigation techniques disclosed herein can be shown to significantly reduce the degree of social bias reflected in a language model and in text generated by such language model. To quantitatively evaluate the extent of social bias in a given language model, one scoring metric that can be used is the Sentence Encoder Association Test (“SEAT”) score, as disclosed in May et al., “On Measuring Social Biases in Sentence Encoders”, Proceedings of the 2019 Conference of the North American Chapter of the Association for Computational Linguistics: Human Language Technologies, pages 622-628 (2019). The SEAT score measures associations between contextual representations of two sets of target concepts (for example, “family” and “career”) and two sets of attributes (for example, “male” and “female”). Six embedding association tests are used to measure bias in sentence embeddings on a scale in the range of {0, ∞}, with higher scores indicating higher degrees of embedded bias in the language model. As used herein, an average of the six tests is used as the SEAT score.

Another scoring metric that can be used to quantitatively evaluate the extent of social bias in a given language model is the Causal Bias (“CB”) score, as disclosed in Qian et al., “Reducing Gender Bias in Word-Level Language Models with a Gender-Equalizing Loss Function”, Proceedings of the 57th Annual Meeting of the Association for Computational Linguistics: Student Research Workshop (2019). The CB score quantifies bias in a language model using causal testing. More specifically, the CB score quantifies bias using a set of templates to evaluate causal occupation bias conditioned on gender (CB|g) or race (CB|r), and to evaluate causal gender/race bias conditioned on occupation (CB|o).

In one set of experiments, SEAT and CB scores were used to evaluate the degree of embedded bias in four different base-uncased language models: the aforementioned BERT language model; BERT having been further trained on small training corpus 126 (“PT BERT”); BERT having been subjected to equalization training 104 (that is, equalized language model 144) (“Equalize BERT”); and BERT having been subjected to equalization training 104 and de-clustering training 106 (that is, debiased language model 108) (“Debias BERT”). In these experiments three different corpora were used for small training corpus 126: the aforementioned CNN/DailyMail corpus, the aforementioned WikiText-103 corpus, and the aforementioned Brown Corpus. Approximately one million sentences were considered from each of these corpora, with an average of 22 tokens per sentence. Equalization training 104 and de-clustering training 106 were performed until the corresponding losses converged. For equalization training 104 convergence took three epochs, while for de-clustering training 106 convergence took an additional one to three epochs. Additional or fewer epochs may be used depending on the loss convergence rate. Values for equalization loss weight λ_{eq}, de-clustering loss weight λ_{dc}, and bias penalization loss weight λ_{bp} that provided a high degree of debiasing are listed in the experimental results below. For training, a batch size of 32, a learning rate of 10⁻⁴, and a maximum sequence length of 128 was used. The results of these experiments are provided in Table 1.

TABLE 1
SEAT and CB scores to measure gender and race bias in BERT and its variants

| | Gender | | | Race | | |
|---|---|---|---|---|---|---|
| | SEAT | | | SEAT | | |
| Model | (λ_{eq} = λ_{dc}) | CB \| g | CB \| o | (λ_{eq} = λ_{dc}) | CB \| g | CB \| o |
| BERT | 0.355 | 0.323 | 0.128 | 0.236 | 0.348 | 0.505 |

CNN/DailyMail

| | | | | | | |
|---|---|---|---|---|---|---|
| PT | 0.352 | 0.513 | 1.105 | 0.490 | 0.998 | 1.961 |
| BERT | | | | | | |
| Equalize | 0.135 (1.00) | 0.162 | 0.008 | 0.368 (0.25) | 0.154 | 0.338 |
| BERT | | | | | | |
| Debias | 0.100 (1.00) | 0.127 | 0.004 | 0.314 (1.00) | 0.112 | 0.166 |
| BERT | | | | | | |

WikiText-103

| | | | | | | |
|---|---|---|---|---|---|---|
| PT | 0.473 | 1.002 | 0.919 | 0.206 | 2.193 | 2.428 |
| BERT | | | | | | |
| Equalize | 0.173 (0.75) | 0.196 | 0.009 | 0.132 (0.50) | 0.156 | 0.109 |
| BERT | | | | | | |
| Debias | 0.422 (1.00) | 0.118 | 0.005 | 0.284 (1.00) | 1.040 | 0.271 |
| BERT | | | | | | |

Brown Corpus

| | | | | | | |
|---|---|---|---|---|---|---|
| PT | 0.373 | 0.774 | 1.512 | 0.396 | 1.300 | 3.773 |
| BERT | | | | | | |
| Equalize | 0.255 (1.25) | 0.356 | 0.150 | 0.222 (0.75) | 0.652 | 1.097 |
| BERT | | | | | | |
| Debias | 0.172 (1.00) | 0.352 | 0.134 | 0.274 (1.00) | 0.918 | 0.732 |
| BERT | | | | | | |

The results provided in Table 1 illustrate that Debias BERT results in reduced levels of gender bias for the CNN/DailyMail and Brown Corpus as measured by both SEAT and CB scores, and results in reduced levels of gender bias for all three corpora as measured by CB scores. Likewise, Debias BERT results in reduced levels of race bias for the CNN/DailyMail corpus as measured by both SEAT and CB scores. The effectiveness of a particular debiasing technique may depend, in part, on the amount of objectionable material present in small training corpus 126. But overall, these experimental results demonstrate that certain of the techniques disclosed herein help to mitigate existing biases in language models such as BERT. In addition to the results shown in Table 1, Debias BERT also outperformed post-processing debiasing of BERT (SEAT=0.256 for Brown Corpus), as described in Liang et al., “Towards Debiasing Sentence Representations”, Proceedings of the 58th Annual Meeting of the Association of Computational Linguistics, pages 5502-5515 (2020). This shows that certain of the in-training debiasing techniques disclosed herein outperform post-processing techniques applied to sentence debiasing.

To quantitatively evaluate the quality of text generated via an abstractive summarization task, one scoring metric that can be used is Recall-Oriented Understudy for Gisting Evaluation (“ROUGE”), as disclosed in Lin, “ROUGE: A Package for Automatic Evaluation of Summaries”, Text Summarization Branches Out, Association for Computational Linguistics Anthology W04-1013, pages 74-81 (2004). ROUGE uses multiple scores, referred to herein as R-1, R-2, and R-L, to measure the quality of a generated summary by comparing the generated summary to human generated summaries. The scores count the number of overlapping units such as n-grams, word sequences, and word pairs between the computer-generated summary to be evaluated and the ideal summaries created by humans.

To quantitively evaluate the fluency of text generated via an abstractive summarization task, scoring metrics that can be used include “perplexity” (“PPL”) and the syntactic log-odds ratio (“SLR”). Both of these metrics are described in Kann et al., “Sentence-Level Fluency Evaluation: References Help, But Can Be Spared!”, Proceedings of the 22nd Conference on Computational Natural Language Learning, pages 313-323 (2018). Perplexity corresponds to the exponentiated cross-entropy, which in turn corresponds to a probability which is normalized by sentence length. SLR is a normalized language model score that provides a metric for referenceless fluency evaluation of natural language generation output at the sentence level.

To quantitatively evaluate the degree of bias reflected in text generated via an abstractive summarization task, the aforementioned constrained co-occurrence score CCO can be used, additional details with respect to which are provided above.

In another set of experiments, ROUGE, CCO, perplexity, and SLR scores were used to evaluate text generated using four different encoder-decoder networks: BERT in conjunction with transformer-based decoder 114 (“BERT+decode”); Debias BERT in conjunction with transformer-based decoder 114 (“Debias BERT+decode”); and Debias BERT in conjunction with debiased transformer-based decoder 120 (“Debias BERT Gen”). In these experiments two different corpora were used for small training corpus 126: the aforementioned CNN/DailyMail corpus; and a corpus of articles and accompanying summaries from news outlet BBC (“XSum”), as described in Narayan et al., “Don't Give Me the Details, Just the Summary! Topic-Aware Convolutional Neural Networks for Extreme Summarization”, Proceedings of the 2018 Conference on Empirical Methods in Natural Language Processing, pages 1797-1807 (2018). Approximately one million sentences were considered from each of these corpora, with an average of 22 tokens per sentence. Bias penalization loss weight λ_{bs} was set to 1.00. The results of these experiments are provided in Table 2.

TABLE 2
ROGUE, CCO, PPL, and SLR scores to evaluate generated text

| | Gender | | | | | | Race | | | | | |
|---|---|---|---|---|---|---|---|---|---|---|---|---|
| Model | R-1 | R-2 | R-L | CCO | PPL | SLR | R-1 | R-2 | R-L | CCO | PPL | SLR |

CNN/DailyMail

| | | | | | | | | | | | | |
|---|---|---|---|---|---|---|---|---|---|---|---|---|
| BERT + | 40.74 | 18.66 | 37.90 | 1.902 | 1.938 | 19.921 | 40.74 | 18.66 | 37.90 | 0.068 | 1.938 | 19.921 |
| decode | | | | | | | | | | | | |
| Debias | 40.15 | 18.13 | 37.18 | 1.833 | 1.894 | 19.951 | 40.29 | 18.31 | 37.40 | 0.065 | 1.905 | 19.943 |
| BERT + | | | | | | | | | | | | |
| decode | | | | | | | | | | | | |
| Debias | 40.03 | 18.07 | 37.18 | 0.991 | 1.908 | 19.897 | 40.32 | 18.27 | 37.51 | 0.044 | 1.913 | 19.894 |
| BERT | | | | | | | | | | | | |
| Gen | | | | | | | | | | | | |

XSum

| | | | | | | | | | | | | |
|---|---|---|---|---|---|---|---|---|---|---|---|---|
| BERT + | 33.87 | 13.22 | 25.63 | 2.131 | 2.370 | 18.986 | 33.87 | 13.22 | 25.63 | 0.080 | 2.370 | 18.986 |
| decode | | | | | | | | | | | | |
| Debias | 33.34 | 12.82 | 25.07 | 2.123 | 2.398 | 19.055 | 33.34 | 12.85 | 25.13 | 0.063 | 2.625 | 19.237 |
| BERT + | | | | | | | | | | | | |
| decode | | | | | | | | | | | | |
| Debias | 33.05 | 12.68 | 25.01 | 0.352 | 2.391 | 19.069 | 31.12 | 10.44 | 22.62 | 0.003 | 2.476 | 18.908 |
| BERT | | | | | | | | | | | | |
| Gen | | | | | | | | | | | | |

The results provided in Table 2 illustrate that the quality of the generated text, as measured by R-1, R-2, and R-L remains substantially similar upon debiasing the encoder and/or decoder for both training corpora and for both gender and race debiasing. Similarly, the fluency scores, as measured by PPL and SLR, remain almost constant upon debiasing. The CCO scores, which measure the degree of bias reflected in the generated text, drop significantly from using BERT+decode as the language model to using Debias BERT Gen as the language model. These experimental results demonstrate that certain of the techniques disclosed herein help to mitigate bias in generated text while still preserving quality and fluency.

Additional Example Implementations

In one example implementation, a computer-implemented method of training a language model to mitigate bias comprises defining a tuple. The tuple includes a first token that defines a first group of people and a second token that defines a second group of people. The method further comprises determining an equalization loss based on respective first and second probabilities of the first and second tokens occurring at a particular point in text generated by the language model. The method further comprises training the language model using a first training corpus and the equalization loss, thereby producing an equalized language model. The method further comprises identifying a first group of socially marked words having a closer association, in a second training corpus, with the first group of people than the second group of people. The method further comprises identifying a second group of socially marked words having a closer association, in the second training corpus, with the second group of people than the first group of people. The method further comprises determining a de-clustering loss based on respective first and second percentages of words proximate to a particular point in text generated by the equalized language model that are included in the respective first and second groups of socially marked words. The method further comprises training the equalized language model using the first training corpus and the de-clustering loss, thereby producing a debiased language model. In some implementations the de-clustering loss penalizes solutions that cause the first and second percentages to be different. In some implementations the de-clustering loss corresponds to a ratio of the first percentage to the second percentage. In some implementations a same training corpus is used for the first and second training corpora. In some implementations the equalization loss penalizes solutions that cause the first and second probabilities to be different. In some implementations the equalization loss corresponds to a ratio of the first probability to the second probability. In some implementations the method further comprises (a) training the debiased language model and a transformer-based decoder using a task-specific training corpus, wherein the debiased language model functions as an encoder; and (b) using the trained encoder and decoder to generate text that summarizes the task-specific training corpus. In some cases the method further comprises training the debiased language model and a transformer-based decoder using a task-specific training corpus, wherein the debiased language model functions as an encoder.

In another example implementation, a system for generating text using a trained language model comprises an encoder that includes a debiased language model that penalizes generated text based on an equalization loss that quantifies first and second probabilities of respective first and second tokens occurring at a first point in the generated text. The first and second tokens define respective first and second groups of people. The system further comprises a decoder configured to generate text using the debiased language model. The decoder is further configured to penalize the generated text based on a bias penalization loss that quantifies respective probabilities of the first and second tokens co-occurring with a generated word. The encoder and decoder are trained to produce the generated text using a task-specific training corpus. In some implementations the system further comprises a socially marked word selection module configured to (a) identify, from a generalized training corpus, a first group of socially marked words as words having a closer association with the first group of people than the second group of people; and (b) identify, from the generalized training corpus, a second group of socially marked words as words having a closer association with the second group of people than the first group of people; wherein the debiased language model further penalizes the generated text based on a de-clustering loss that quantifies first and second percentages of words proximate to a second point in the generated text that are included in the respective first and second groups of socially marked words. In some implementations the equalization loss corresponds to a ratio of the first probability to the second probability. In some implementations the encoder and decoder are trained based on the equalization loss and the bias penalization loss before the encoder and decoder are used to produce the generated text. In some implementations (a) the encoder is trained on a small training corpus using the equalization loss; and (b) the small training corpus is distinct from the task-specific training corpus. In some implementations the equalization loss quantifies the first and second probabilities using a plurality of different pairs of first and second tokens that define the respective first and second groups of people. In some implementations the first group of people is male and the second group of people is female.

In another example implementation, a non-transitory computer readable medium is encoded with instructions that, when executed by one or more processors, cause a process for training a language model to be carried out. The process comprises defining a tuple that includes a first token that defines a first group of people and a second token that defines a second group of people. The process further comprises collecting a set of words from a relatively smaller training corpus. The process further comprises determining a contextual representation for each of the words in the set. Each contextual representation is extracted from the language model, the language model having been trained on a relatively larger training corpus. The process further comprises identifying a first group of socially marked words for the first group of people by projecting the contextual representations onto an axis defined by the first and second tokens. The socially marked words in the first group are more closely associated with the first group of people than the second group of people. The process further comprises identifying a second group of socially marked words for the second group of people based on the projected contextual representations. The socially marked words in the second group are more closely associated with the second group of people than the first group of people. The process further comprises determining a de-clustering loss based on first and second percentages of words proximate to a first point in text generated by the language model that are included in the respective first and second groups of socially marked words. In some implementations the de-clustering loss is determined before the language model is used to generate text. In some implementations the extracted contextual representations are obtained using a sum of vectors from selected layers of the language model. In some implementations (a) the first group of people are people of a first race; and (b) the second group of people are people of a second race. In some implementations the process further comprises determining an equalization loss that depends on first and second probabilities of the respective first and second tokens occurring at a second point in the text generated by the language model.

### CONCLUSION

The foregoing disclosure has been presented for the purposes of illustration and description. It is not intended to be exhaustive or to be limited to the particular described embodiments. Many modifications and variations are possible. It is therefore intended that the scope of the invention be limited not by this detailed description, but rather by the claims appended hereto. The examples mentioned here are only to illustrate example embodiments and there is no intent for discrimination. The inventors and the applicant honor and respect all demographic preferences. The aim of this work is to help provide technical tools to avoid amplification of discrimination and biases.

What is claimed is:

1. A computer-implemented method of training a language model to mitigate bias, the method comprising:
defining a tuple that includes a first token that defines a first group of people and a second token that defines a second group of people;
determining an equalization loss based on respective first and second probabilities of the first and second tokens occurring at a particular point in text generated by the language model;
training the language model using a first training corpus and the equalization loss, thereby producing an equalized language model;
identifying a first group of socially marked words having a closer association, in a second training corpus, with the first group of people than the second group of people;
identifying a second group of socially marked words having a closer association, in the second training corpus, with the second group of people than the first group of people;
determining a de-clustering loss based on respective first and second percentages of words proximate to a particular point in text generated by the equalized language model that are included in the respective first and second groups of socially marked words; and
training the equalized language model using the first training corpus and the de-clustering loss, thereby producing a debiased language model.

2. The method of claim 1, wherein the de-clustering loss penalizes solutions that cause the first and second percentages to be different.

3. The method of claim 1, wherein the de-clustering loss corresponds to a ratio of the first percentage to the second percentage.

4. The method of claim 1, wherein a same training corpus is used for the first and second training corpora.

5. The method of claim 1, wherein the equalization loss penalizes solutions that cause the first and second probabilities to be different.

6. The method of claim 1, wherein the equalization loss corresponds to a ratio of the first probability to the second probability.

7. The method of claim 1, further comprising:
training the debiased language model and a transformer-based decoder using a task-specific training corpus, wherein the debiased language model functions as an encoder; and
using the trained encoder and decoder to generate text that summarizes the task-specific training corpus.

8. The method of claim 1, further comprising training the debiased language model and a transformer-based decoder using a task-specific training corpus, wherein the debiased language model functions as an encoder.

9. A system for generating text using a trained language model, the system comprising:
an encoder that includes a debiased language model that penalizes generated text based on an equalization loss that quantifies first and second probabilities of respective first and second tokens occurring at a first point in the generated text, wherein the first and second tokens define respective first and second groups of people; and
a decoder configured to generate text using the debiased language model, wherein the decoder is further configured to penalize the generated text based on a bias penalization loss that quantifies respective probabilities of the first and second tokens co-occurring with a generated word;
wherein the encoder and decoder are trained to produce the generated text using a task-specific training corpus.

10. The system of claim 9, further comprising a socially marked word selection module configured to:
identify, from a generalized training corpus, a first group of socially marked words as words having a closer association with the first group of people than the second group of people; and
identify, from the generalized training corpus, a second group of socially marked words as words having a closer association with the second group of people than the first group of people;
wherein the debiased language model further penalizes the generated text based on a de-clustering loss that quantifies first and second percentages of words proximate to a second point in the generated text that are included in the respective first and second groups of socially marked words.

11. The system of claim 9, wherein the equalization loss corresponds to a ratio of the first probability to the second probability.

12. The system of claim 9, wherein the encoder and decoder are trained based on the equalization loss and the bias penalization loss before the encoder and decoder are used to produce the generated text.

13. The system of claim 9, wherein:
the encoder is trained on a small training corpus using the equalization loss; and
the small training corpus is distinct from the task-specific training corpus.

14. The system of claim 9, wherein the equalization loss quantifies the first and second probabilities using a plurality of different pairs of first and second tokens that define the respective first and second groups of people.

15. The system of claim 9, wherein the first group of people is male and the second group of people is female.

16. A non-transitory computer readable medium encoded with instructions that, when executed by one or more processors, cause a process for training a language model to be carried out, the process comprising:
defining a tuple that includes a first token that defines a first group of people and a second token that defines a second group of people;
collecting a set of words from a relatively smaller training corpus;
determining a contextual representation for each of the words in the set, wherein each contextual representation is extracted from the language model, the language model having been trained on a relatively larger training corpus;
identifying a first group of socially marked words for the first group of people by projecting the contextual representations onto an axis defined by the first and second tokens, wherein the socially marked words in the first group are more closely associated with the first group of people than the second group of people;
identifying a second group of socially marked words for the second group of people based on the projected contextual representations, wherein the socially marked words in the second group are more closely associated with the second group of people than the first group of people; and
determining a de-clustering loss based on first and second percentages of words proximate to a first point in text generated by the language model that are included in the respective first and second groups of socially marked words.

17. The non-transitory computer readable medium of claim 16, wherein the de-clustering loss is determined before the language model is used to generate text.

18. The non-transitory computer readable medium of claim 16, wherein the extracted contextual representations are obtained using a sum of vectors from selected layers of the language model.

19. The non-transitory computer readable medium of claim 16, wherein:
the first group of people are people of a first race; and
the second group of people are people of a second race.

20. The non-transitory computer readable medium of claim 16, wherein the process further comprises determining an equalization loss that depends on first and second probabilities of the respective first and second tokens occurring at a second point in the text generated by the language model.
